(19) United States
(12) Patent Application Publication
(10) Pub. No.: US 2010/0119334 A1
(43) Pub. Date: May 13, 2010

(54) BINDING OF STACKED FLAT PARTS

(75) Inventor: Ferdinand FUCHS, Nuertingen (DE)

Correspondence Address: GREENBLUM & BERNSTEIN, P.L.C., 1950 ROLAND CLARKE PLACE, RESTON, VA, 20191, US

(73) Assignee: KUGLER-WOMAKO GMBH, Nuertingen (DE)

(21) Appl. No.: 12/576,636

(22) Filed: Oct. 9, 2009

(30) Foreign Application Priority Data
Oct. 14, 2008 (DE) 202008013619.9
Mar. 9, 2009 (DE) 102009011699.0

(51) Int. Cl. B42B 5/10

(52) U.S. Cl. 412/7; 412/39

(57) ABSTRACT

A wire comb for binding stacked flat parts, a method of binding stacked flat parts with the wire comb, and a device for binding stacked flat parts with the wire comb. The wire comb includes loop-like or hairpin-like sections insertable into perforations formed in the flat parts, and wire sections arranged next to each other in a longitudinal direction that combine together the loop-like or hairpin-like sections. In an open state before insertion of the loop-like or hairpin-like sections into the perforations, the wire comb has a cross-section in which the loop-like or hairpin-like sections are straight on an insertion side and in which a side facing the straight loop-like or hairpin-like sections is bent or prerounded.

### CROSS-REFERENCE TO RELATED APPLICATIONS

The present application claims priority under 35 U.S.C. §119(a) of German Patent Application No. 20 2008 013 619.9 filed Oct. 14, 2008 and of German Patent Application No. 10 2009 011 699.0 filed Mar. 9, 2009, the disclosures of which are expressly incorporated by reference herein in their entireties.

### BACKGROUND OF THE INVENTION

1. Field of the Invention

The invention relates to a wire comb for the binding of stacked flat parts, in particular sheets of paper, wherein the wire comb has loop-like or hairpin-like sections, which can be inserted or are inserted in perforations of the flat parts, perforations preferably provided in edge areas of the flat parts, and in wire sections arranged next to each other in the longitudinal direction of the wire comb, which combine together the loop-like or hairpin-like sections, preferably on their far side. Furthermore, the invention relates to the use of a wire comb for binding stacked flat parts, in particular sheets of paper, and a device for the binding of stacked flat parts, in particular sheets of paper.

2. Discussion of Background Information

Blocks or stacked flat parts made of paper or the like, such as brochures, user's guides, calendars, notepads, etc., should they need to be opened easily, will be bound with wire or a so-called wire comb.

Notepads include, for example, a stable base sheet and cover sheet, which protect the paper content. The entire paper stack is perforated on one side or is provided with prepunched holes, into which the wire comb will be inserted and closed. The wire binding makes it possible to open or page through the paper stack without reset forces can turn up the paper.

According to the state of the art, there are C-shaped pre-bent wire combs, the so-called twin wires. These are positioned over the prepunched or perforated sheets of paper that are preformed with a radius. By pushing the open C-shaped wire combs together, closed ring-shaped wire combs are created, which hold the sheets of paper together. There are suitably coordinated wire comb diameters for each number of sheets or each paper stack thickness. The C shape of the wire comb restricts the paper layer thickness, since the wire comb is pushed over the paper layer. If the paper thickness varies, the result can be malfunctions in the binding process.

When the C-shaped wire comb is closed, it must be bent far enough over so that it does not lose paper from the closed wire ring after the wire springs back. This mainly leads to problems in the case of thicker stacks, since these wire combs must be bent far enough over so that a remaining deformation of the wire leads to a non-roundness of the wire comb. The wire binding then assumes a cross-section that is the shape of an ellipse rather than the shape of a desired, optically correct circle with a predetermined radius.

EP-A-1 348 571 discloses an apparatus and a method for the binding of stacked flat parts, in particular sheets of paper, with the help of a somewhat long fastener. This fastener has, in cross-section, two bent side sections, which are opened before insertion into the perforations designed in the edge sections of the flat parts and are closed after insertion. A wire comb is hereby used as a fastener, and the open fastener is inserted into the perforations with the help of an insertion device and the fastener inserted into the perforations is closed with the help of a closing device.

A device of the aforementioned type is usually part of a semi-automatic or fully automatic system for the production of notepads, which are held together by wire combs. In these types of systems, sheets of paper are created from a paper web through cutting. During this work step, the sheets of paper are perforated simultaneously in an edge section with the help of a punch device and are printed in a printing device, if applicable. These sheets of paper are then overlapped and collected into pads with a defined number of sheets of paper.

The sheets of paper are thereby stacked such that the perforated edge sections are aligned with each other. The latter is important in order to be able to insert and push the wire combs, which are still open at this time, with their one bracket through the perforations of all sheets of paper in the binding device for binding the notepads. The still open wire combs are then closed in that the spaced brackets are bent towards each other in order to form in this manner closed ring-shaped segments.

The wire combs in accordance with the state of the art includes a plurality of adjacent bracket or segment pairs, which are connected together through connection sections, and thus have the shape of a “caterpillar” moving diagonal to its longitudinal extension. The wire combs are prefabricated such that they are delivered with opened segments. When open, the segments of each segment pair with their free ends are spaced, whereby each segment pair and thus also the wire combs have a cross-section that is the shape of a double “C”. Due to this special shape, it is important that the wire combs in the binding device are inserted through the perforations of the sheets of paper in as precise a manner as possible in order to enable smooth binding.

For example, a wire comb in the form of a double “C” is known in EP-B-0 285 355 (corresponds with DE-T-38 75 643).

### SUMMARY OF THE INVENTION

Based on this state of the art, the invention improves the binding of stacked flat parts, such as sheets or the like, with a wire comb. The most precise possible and simple insertion of the wire comb into the perforations of the stacked flat parts can be ensured.

According to embodiments of the invention, a wire comb for the binding of stacked flat parts, in particular sheets of paper, is provided. The wire comb has loop-like or hairpin-like sections, which can be inserted or are inserted in perforations of the flat parts, preferably in boundary areas of the perforations provided in the flat parts, and wire sections arranged next to each other in the longitudinal direction of the wire comb. The wire sections combine together the loop-like or hairpin-like sections, preferably on their far side, which is further characterized in that the wire comb in the open state or before insertion of the loop-like or hairpin-like sections into the perforations has a cross-section such that the loop-like or hairpin-like sections are straight on their insertion side and the wire comb is bent or prerounded on the side facing the straight loop-like or hairpin-like sections, preferably in a round-bodied or partial-circle-like manner.

The invention is based on the idea that the wire comb for the binding of paper layers or for the binding of stacks made of perforated sheets in book form, such as notepads, calendars, operating instructions and the like, has straight, hairpin-like or loop-like sections or straight prongs or tines on the insertion side, so that the wire comb on the side facing away from the insertion side, i.e. the side facing the open roots of the wire comb, is pre-rounded and the loop-like or hairpin-like sections or tines on the insertion side are not preformed or straight, i.e. not bent. Straight receiving brackets are thereby provided as tines for the perforated paper layers or the like so that the wire comb with its straight-line, loop-like or hairpin-like sections or brackets can be inserted and then screwed into the perforated flat part stack without bent preforming. During the screwing in of the wire comb according to the invention, the layer of the mounted flat parts or paper layers adjusts itself to the wire curve on the other preformed end of the wire comb.

A wire comb, which manages without complicated prerounding of the flat parts or paper layers to be connected and which also compensates for deviations in the paper layer thickness and looks round or circular when the wire comb is closed, is provided by the wire comb preformed on the side facing the open roots. In this respect, the wire comb according to the invention is insensitive to deviations in the paper thickness so that thicker paper layers can also be bound using the wire comb.

Moreover, one embodiment of the wire comb provides that the wire comb in the open state, i.e. before insertion of the wire comb into the perforation or before closing of the wire comb, has a cross-section in the form of an open “d” or “D” or “P” or “J” and/or the straight-line, loop-like or hairpin-like sections of the wire comb are bent on their outer ends. In particular, the wire comb is made of wire, preferably metal wire or plastic wire. The wire of the wire comb can then be permanently coated or encased, and the coating can be applied to the wire by a galvanic coating and the encasing takes place, e.g., with a tube made of plastic like nylon or the like. For example, a nylon tube for the wire can thereby be transparent or non-transparent.

It is particularly advantageous if the wire comb on the bent or partial-circle-like preformed side is bent or curved over an angle range of equal to or greater than 180°, preferably equal to or greater than 270° (with respect to the cross-section). This results in easy handling of the wire comb upon insertion into the perforations of the flat part stack. Open, straight-line brackets are fed to the perforations of the flat part stack, which are then closed, via the open brackets or tines of the d shape or the D shape or the P shape of the J shape. Compared to C-shaped wire combs or double-C-shaped wire combs according to the state of the art, more paper can thus be inserted into the wire comb according to the invention. In this way, the paper quantity intake capacity of the wire comb increases based on the design according to the invention with straight-line, loop-like or hairpin-like sections or tines for receiving the flat part stack.

In accordance with another advantageous embodiment, it is provided that, in the closed state of the wire comb, the loop-like or hairpin-like sections remain straight or curved. In particular, the flat parts in the closed state of the wire comb are secured from falling out. Through bending of the open bracket or the straight-line, loop-like or hairpin-like sections or tines of the wire comb to a radius or to a straight line, the wire comb does not lose its preformed curve on the preformed side or root side facing away from the straight-line, loop-like or hairpin-like sections, since the closing procedure of the wire comb only takes place in one or two quadrants of the wire comb.

If a base sheet of the flat parts lies on a cover sheet during the closing of the wire comb and if the base sheet is then turned by approximately 360°, this turned base sheet takes the connection bars of the wire comb on the roots of the wire comb and hides them in the paper stack. This causes the bent wire part of the binding to be screwed into the paper and only the mechanically prefabricated or preformed part of the wire comb is visible, whereby the wire comb in the closed state with its preformed curve points outwards and is visible in the connection area of the loop-like or hairpin-like section.

Moreover, the wire comb can be used for the binding of stacked flat parts, in particular sheets of paper or the like. The wire comb is designed as described above. In order to avoid repetitions reference to the above explanations is expressly made.

Embodiments of the invention include a method for the binding of stacked flat parts, in particular sheets of paper. The method utilizes the wire comb described above in such a way that the straight-line, loop-like or hairpin-like sections of the opened or open wire comb will be or are inserted into perforations of the flat parts, preferably perforations provided in edge areas of the flat parts. The loop-like or hairpin-like sections are collected by a pivotable closing device and the closing device for closing the binding or the wire comb is pivoted on a predetermined pivot axis running parallel or collinear along on the longitudinal axis of the wire comb.

This ensures an easy and secure connection of the flat parts. Preferably during the pivot movement of the closing device the pivot axis mainly coincides with the pivot point or the longitudinal axis or the middle point axis of the circular or partial-circle-like preforming of the side of the preformed wire comb facing away from the straight-line loop-like or hairpin-like sections of the wire comb.

For this, it is also provided that the loop-like or hairpin-like sections are inserted into the perforations of the flat parts by a handling device. The handling device preferably performs a linear movement at or during the insertions of the loop-like or hairpin-like sections of the wire comb. After insertion of the entry side of the wire comb, it is possible in one embodiment that the wire comb with its preformed partial-circle-like preforming is turned in further. The layers of the flat parts adjust appropriately to the radius of the partial-circle-like preforming of the wire comb.

Furthermore, it is provided in a preferred further embodiment that the loop-like or hairpin-like sections of the wire comb are captured or clamped in the transition area between the straight-line sections or the prerounded sections by a closing device. In particular, after pivoting of the closing device, the wire comb is closed in a D shape or O shape or circular shape. This results in a simplified handling during the closing process of the wire comb since the wire comb is clamped into the flat parts in the transition area by means of the closing device in particular after the screwing in of the wire comb. In this manner, a simple handling is achieved during the closing process, since after clamping of the loop-like or hairpin-like sections for the closing of the wire comb the pivot movement of the closing device is executed so that the ends of the tines of the wire comb are arranged or bent in the area of the open roots.

Moreover, it is preferably further provided that the insertion of the wire comb and the closing of the wire comb are performed, preferably exclusively, on one single device. After providing a stack with pre-perforated flat parts to be connected, such as notepads or calendars or the like, to a stationary device, the wire comb with its straight-line insertion brackets or straight-line, loop-like or hairpin-like sections is inserted into the perforation channels under a linear movement of the corresponding handling device. The closing process is then performed through pivoting of the closing device after capturing of the free brackets or tines of the wire comb or the free sections by the closing device. This results in a secure and fast binding of the flat parts. The mechanical load of the flat parts is reduced, since the insertion procedure and the closing procedure of the wire comb is performed on the one single stationary device, without the flat parts needing to be transported and/or removed.

Within the framework of the invention, it is also conceivable that the handling device for the insertion of the wire comb as well as the further screwing of the wire comb into the flat parts to be connected and the closing procedure are performed at separate, sequentially arranged (processing) stations.

The embodiments of the invention also include an apparatus for the binding of stacked flat parts, in particular sheets of paper, using the wire comb according to the invention and described above. The apparatus includes a pivotable closing device, which is pivotable around a predetermined pivot axis running parallel or collinear along the longitudinal axis of the wire comb for the closing of the binding. The closing device has a clamping device so that the loop-like or hairpin-like sections of the wire comb, in particular in the transition area between the straight-line sections and the prerounded sections, are captured or clamped by the closing device.

For this, it is also provided that the clamping device has, preferably hook-shaped, projections, which engage behind the loop-like or hairpin-like sections of the wire comb from inside. The projections work together with at least one clamp part, which is or will be arranged on the outside of the sections of the wire comb, wherein in particular the projections and the at least one clamp part can be moved relative to each other.

Furthermore, one embodiment of the apparatus provides that, for the design of the clamping of the sections or of the tines of the wire comb, the projections are moveable linearly, preferably parallel to the longitudinal axis of the wire comb and/or the at least one clamp part can be moved diagonally, preferably perpendicular, to the longitudinal axis of the wire comb.

A positioning device for the alignment of the stacked flat parts is also preferably provided, wherein, in particular by the positioning device, the longitudinal axis of the open wire comb inserted into the perforations of the flat parts is aligned parallel or collinear in the pivot axis of the closing device. This simplifies the handling of the flat parts to be connected together on the apparatus.

A further improvement is thereby achieved in that a handling device or a wire comb insertion device for the insertion of the wire comb into the perforations of the stacked flat parts is provided. In particular, the handling device can be moved linearly during the insertion of the wire comb in to the perforations.

Further characteristics of the invention will become apparent from the description of the embodiments according to the invention together with the claims and the included drawings. Embodiments according to the invention can fulfill individual characteristics or a combination of several characteristics.

Embodiments of the invention are directed to a wire comb for the binding of stacked flat parts. The wire comb includes loop-like or hairpin-like sections insertable into perforations formed in the flat parts, and wire sections arranged next to each other in a longitudinal direction that combine together the loop-like or hairpin-like sections. In an open state before insertion of the loop-like or hairpin-like sections into the perforations, the wire comb has a cross-section in which the loop-like or hairpin-like sections are straight on an insertion side and in which a side facing the straight loop-like or hairpin-like sections is bent or prerounded.

According to embodiments of the invention, the stacked flat part can include sheets of paper and the perforations are formed in edge areas of the sheets of paper. Further, the side facing the loop-like or hairpin-like section can be one of round-bodied or partially circular.

In accordance with embodiments of the present invention, in the open state, the cross-section can form an open “d” or “D” or “P” or “J” and the straight, loop-like or hairpin-like sections may be bent on their outer ends, and the wire comb may be made of wire. The wire comb can be made of metal wire or plastic wire.

In embodiments of the instant invention, the wire comb can be bent or curved on the bent side over an angle range of at least one of equal to or greater than 180° and equal to or greater than 270°.

In a closed state, the loop-like or hairpin-like sections can remain straight or curved. Further, in the closed state, the flat parts can be secured from falling out.

Embodiments of the invention are directed to a method of binding stacked flat part with the wire comb described above. The loop-like or hairpin-like sections may be inserted into the perforations of the stacked flat part.

Embodiments of the invention are directed to a method for the binding of stacked flat parts with the wire comb as described above. The method includes inserting straight-line, loop-like or hairpin-like sections of an opened wire comb into perforations of the flat parts, and closing the loop-like or hairpin-like sections of the opened wire comb with a pivotable closing device. A closing device for closing the wire comb is pivoted on a predetermined pivot axis running parallel or collinearly along a longitudinal axis of the wire comb.

According to embodiments of the invention, the loop-like or hairpin-like sections can be inserted into the perforations by a handling device, and the method may further include linearly moving the loop-like or hairpin-like sections with the handling device while inserting the loop-like or hairpin-like sections.

In accordance with other embodiments of the instant invention, the method can include capturing or clamping the loop-like or hairpin-like sections in a transition area between the straight-line sections and the prerounded sections with a closing device, and pivoting the closing device to form a D or O shaped cross-section.

According to embodiments, the insertion of the loop-like or hairpin-like section and closing of the wire comb can be performed by a single device.

Embodiments of the invention are directed to an apparatus for the binding of stacked flat parts, such as sheets of paper, with a wire comb as described above. The apparatus includes a pivotable closing device arranged to close the binding, the pivotable closing device being pivotable around a predetermined pivot axis running parallel to or collinear along a longitudinal axis of the wire comb, and a clamping device being structured and arranged to capture or clamp a transitional area between the loop-like or hairpin-like sections and the prerounded sections.

According to embodiments of the present invention, the clamping device may include projections structured and arranged to engage the loop-like or hairpin-like sections from behind and from inside, and the projections can work together with at least one clamp part positionable on an outside of the loop-like or hairpin-like sections. The projections can be hook shaped, and the projections and the at least one clamp part may be movable relative to each other.

In accordance with embodiments, at least one of the projections are linearly moveable relative to a longitudinal axis of the wire comb and the at least one clamp part is diagonally movable relative to the longitudinal axis of the wire comb. For clamping, the projections can be movable parallel to the longitudinal axis and the at least one clamp part may be movable perpendicularly to the longitudinal axis.

According to other embodiments of the instant invention, the apparatus can include a positioning device for the alignment of the stacked flat parts. The positioning device further parallelly or collinearly aligns the longitudinal axis of the open wire comb to be inserted into the perforations to the pivot axis.

In accordance with still yet other embodiments of the present invention, a handling device is arranged for inserting the wire comb into the perforations of the stacked flat parts. The handling device can be linearly movable during the inserting of the wire comb into the perforations.

Other exemplary embodiments and advantages of the present invention may be ascertained by reviewing the present disclosure and the accompanying drawing.

### BRIEF DESCRIPTION OF THE DRAWINGS

The invention is described below, without restricting the general intent of the invention, based on an exemplary embodiment, wherein references to the figures is expressly made with regard to the disclosure of all details according to the invention that are not explained in greater detail in the text. The drawings show in:

FIG. 1a, 1b schematically illustrate a wire comb according to the invention from the top and a cross-sectional view from the side;

FIG. 2a, 2b, 2c schematically illustrate different schematic views of a block made of sheets of paper;

FIG. 3a schematically illustrates an open wire comb form and a pre-perforated block of sheets of paper;

FIG. 3b, 3c each schematically illustrates a wire comb inserted or screwed into the block of paper sheets in cross-section;

FIG. 4a, 4b schematically illustrates a closing device;

FIG. 5 schematically illustrates a cross-sectional view of the closing device;

FIG. 6 schematically illustrates another cross-sectional view of the closing device;

FIG. 7a, 7b, 7c each schematically illustrate a cross-sectional view of the closing device for round formation of a wire comb in several work steps and

FIG. 8a, 8b, 8c schematically illustrate different cross-sectional views of a wire comb according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following figures, the same or similar types of elements or corresponding parts are provided with the same reference numbers in order to prevent the item from needing to be reintroduced.

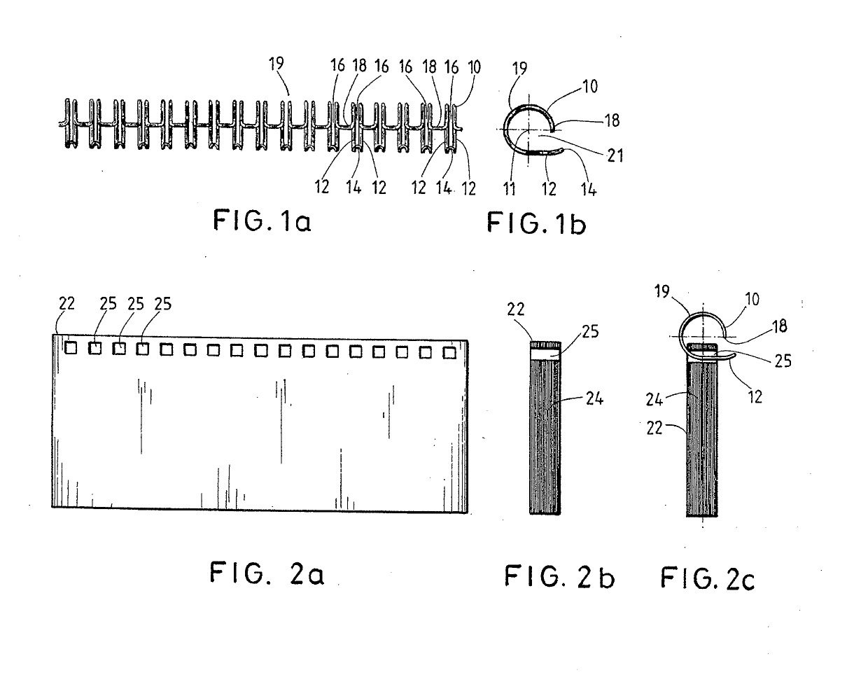

FIG. 1a shows a view of the top of a wire comb 10 and FIG. 1b shows a cross-sectional view through the wire comb 10. The wire comb 10 is designed like a comb and has loop-like or hairpin-like sections designed like prongs or tines 12 on the insertion side, which lie or are arranged next to each other. The tines 12 are closed at their tips 14 and open at their roots 16 on the top side of the wire comb 10. The roots 16 of the wire comb 10 are connected through intermediate, straight wire lengths 18.

As can be seen in the cross-sectional view in FIG. 1b, the tines 12 on the insertion side are straight, i.e. not bent, and then the wire comb 10 transitions into a preformed, bent shape, which is preformed in an appropriately partial-circle-like manner like a bulge above the straight-line tines 12. On the front side or on the end of the tines 12, the tips 14 have a small, hook-shaped bend so that, upon insertion of the tines 12 into the perforations of flat parts, a simple, linear insertion of the tines is enabled.

Furthermore, it can be seen in the cross-sectional representation in FIG. 1b that the wire comb in cross-section is open between the wire lengths 18 and the straight tines 12, wherein the wire comb 10 is rounded or bent over an angle area of e.g. 270° on the side facing away from the tips 14, i.e. on the side of the roots 16. After insertion of the hairpin-like, bent and adjacent tines 12 into the perforations of flat parts, the straight tines 12 available as short, open brackets for the formation of a binding are bent to a radius or also to a straight line. In this manner, the wire comb 10 does not lose its preformed (partial-circle-like) curve on its back side 19, since the closing procedure takes place in the open quadrants 21 of the wire comb 10.

FIG. 2a shows a view of the top of a stack or block 22 made up of several paper sheets 24. The paper sheets 24 (see 2c) are arranged stacked on top of each other and have perforation holes 25 in the upper edge area. In the case of the block-wise or stack-wise arrangement of the paper sheets 24, a type of channel is formed, through which the non-bent, i.e. straight, tines 12 of the wire comb 10 are inserted with a linear movement of the wire comb 10 (see FIG. 2c).

FIG. 2b shows a cross-section through the block 22 with several paper sheets 24. FIG. 2c shows the block 22 with a wire comb 10 inserted or pushed into the perforations holes 25.

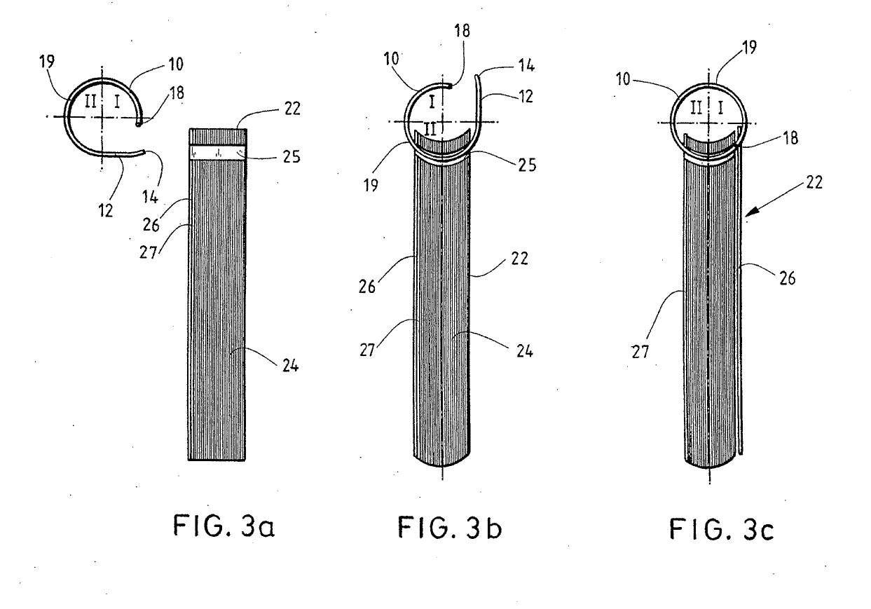

FIG. 3a shows a cross-section of a block 22 of stacked paper sheets 24. A pre-perforated base sheet 26 and a pre-perforated cover sheet 27 are also hereby arranged on the left side of the block 22. For the insertion of the wire comb 10 with its straight-line tines 12 into the perforation holes 25, it is not required to design the block 22 with a curve in order to form a curved channel from perforation holes 25.

The block 22 thus no longer needs to be bent or otherwise mechanically processed or preformed upon insertion of the wire comb 10 in order to enable an insertion of the tines 12.

The left part of FIG. 3a shows a schematic cross-sectional view of wire comb 10, wherein quadrant fields I and II are drawn in for better orientation during the handling of the wire comb 10. After a linear insertion movement of the wire comb into the perforation holes 25, the wire comb 10 is screwed in further, as shown in FIG. 3b. The paper sheets 24 of the block 22 hereby adjust to the radius of the wire comb 10. The tines 12 of the wire comb 10 are then bent further so that the tips 14 of the tines 12 are arranged between roots 16 of the wire comb 10, as shown in FIG. 3c. When the wire comb 10 is closed, its cross-section is radius-like so that the block 22 with the paper sheets 24 cannot fall out.

In an alternative embodiment, the straight-line tines 12 are not bent during the closing procedure so that when the tips 14 approach the roots 16 of the wire comb 10 it has a straight section on one side so that the cross-section of the closed wire comb 10 is shaped like a D.

FIG. 3c shows the closed state of the wire comb 10. The base sheet 26 is then turned 360° after the closing of the wire comb 10 so that the base sheet 26 takes the connection bars or the wire lengths 18 (see FIG. 1b) of the wire comb 10 so the connection bars or wire lengths 18 now lie covered in the paper stack between the paper sheets and the base sheet 26. This causes the bent part of the bonding to be screwed into the paper and into the block 22 during the closing of the wire comb 10 and only the prerounded or preformed partial-circle-like part of the wire comb 10 with its back side 19 is or will be visible.

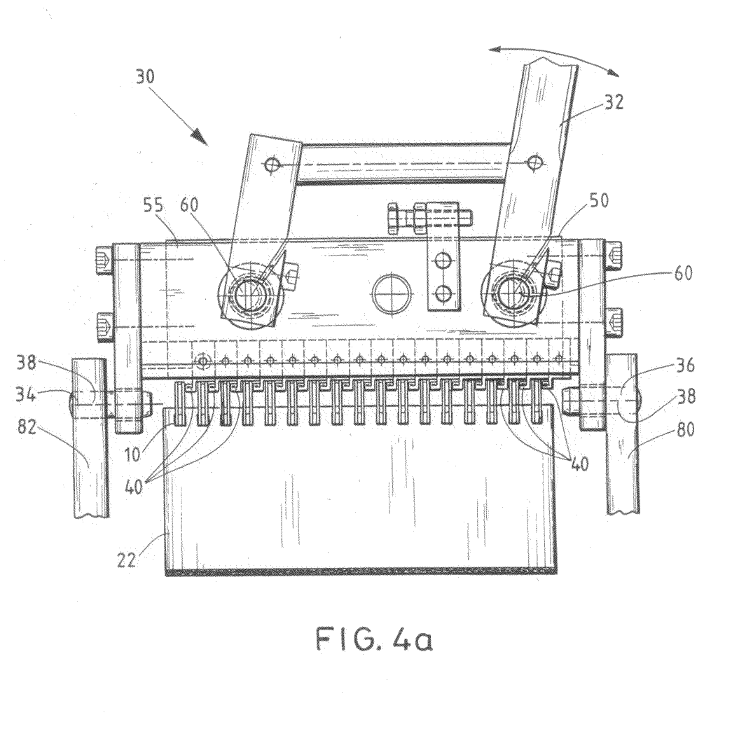

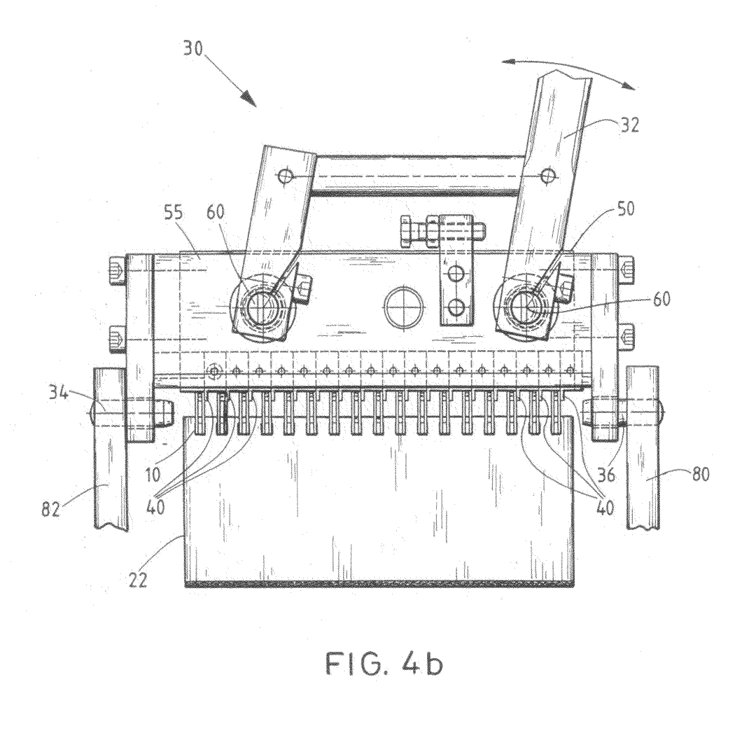

FIGS. 4a, 4b are both schematic views of a closing device 30. FIG. 4a shows the receiving position of the closing device 30 for receiving the open wire comb 10 inserted into the block 22. FIG. 4b shows the working position of the pivot device 30 when the wire comb 10 is clamped.

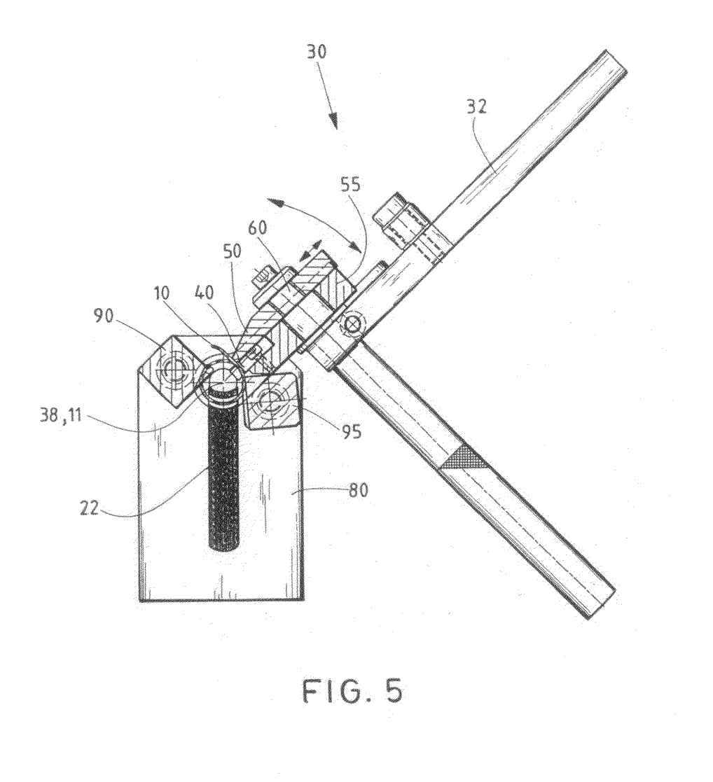

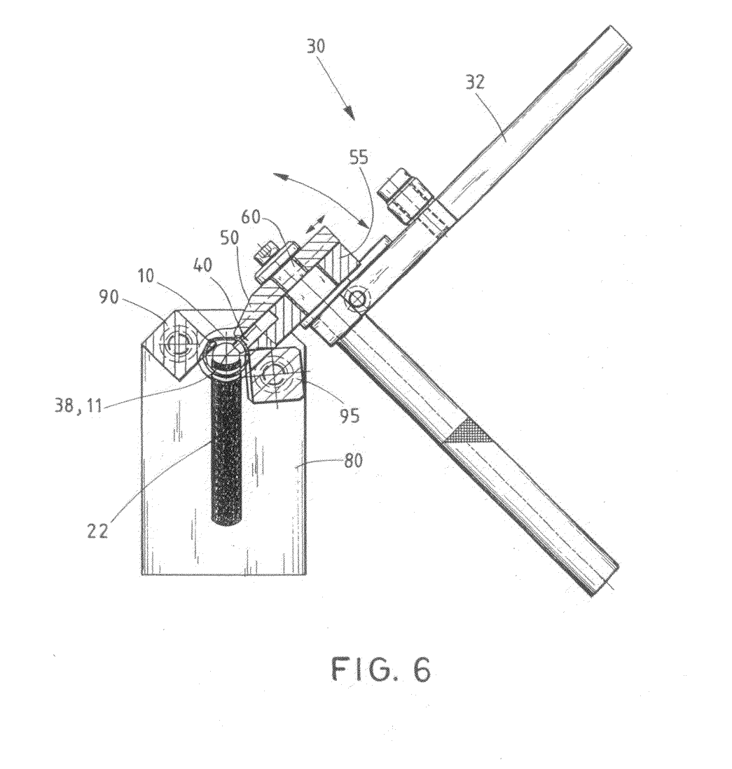

In FIG. 4a, the unshaped and open wire comb 10 are hung in with receiving rails (not shown here) (see FIGS. 5 and 6, reference numbers 90, 95). The closing device 30 has an activation lever 32, which is connected with two eccentric shafts 60. The eccentric shaft 60 is operatively connected with a closing rail 50 on the top side (see FIG. 5). The closing rail 50 is arranged on a mounting plate 55, and Z-shaped bending anvils 40, which receive the wire comb 10, engage behind the loop-like sections of the wire comb 10 from the inside through a linear sliding of the closing device 30 onto the laterally arranged pins 34, 36 on the plates 80, 82.

The plates 80, 82 are stationary with the pins 34, 36 and form the attachment points of the closing device 30 that can be moved linearly on the pins 34, 36 or its mounting plate 55. Through the linear shifting of the closing device 30, the bending anvils 40 engage behind the hairpin-like or loop-like, bent and adjacent sections or tines 12 in the transition area between the partial-circle-like, pre-bent part and the linear area of the hairpin-like, bent and adjacent tines 12 (see FIG. 4b).

Furthermore, the closing rail 50 is pushed against the tines of the wire comb 10 from the outside (see FIG. 5) through activation of the activation lever 32 via the eccentric shaft 60 so that upon execution of a pivot movement of the closing device 30 additionally swivel mounted on the pins 34, 36, the wire comb 10 is closed through a binding by the wire comb.

FIG. 5 shows a cross-section through the closing device 30 in FIG. 4b.

The closing device 30 can be pivoted around a pivot axis 38, which coincides collinearly with the center axis of the pins 34, 36. Furthermore, the pivot axis 38 is collinear to the central axis or longitudinal axis of the wire comb 10. In FIG. 1b, the central axis of the wire comb 10 is provided with reference number 11. The establishment of a binding means that the wire comb 10 is closed so that an individual sheet cannot be removed or cannot by itself fall out of the bound paper stack 24 from wire comb 10.

As can be seen in the cross-sectional representations in FIG. 5 and FIG. 6, the block 22 together with the wire comb 10 is hung in between the plates 80, 82 from both sides via receiving rails 90, 95, wherein the block 22 hangs freely in the wire comb 10.

FIG. 5 shows a cross-section view of the working position, in which the closing rail 50 bends the wire comb 10 over the eccentric shaft 60 on the bending anvil 40.

FIG. 6 shows a cross-section of a position, in which the wire comb 10 is closed, so that the wire comb 10 has a straight, i.e. non-bent, bracket.

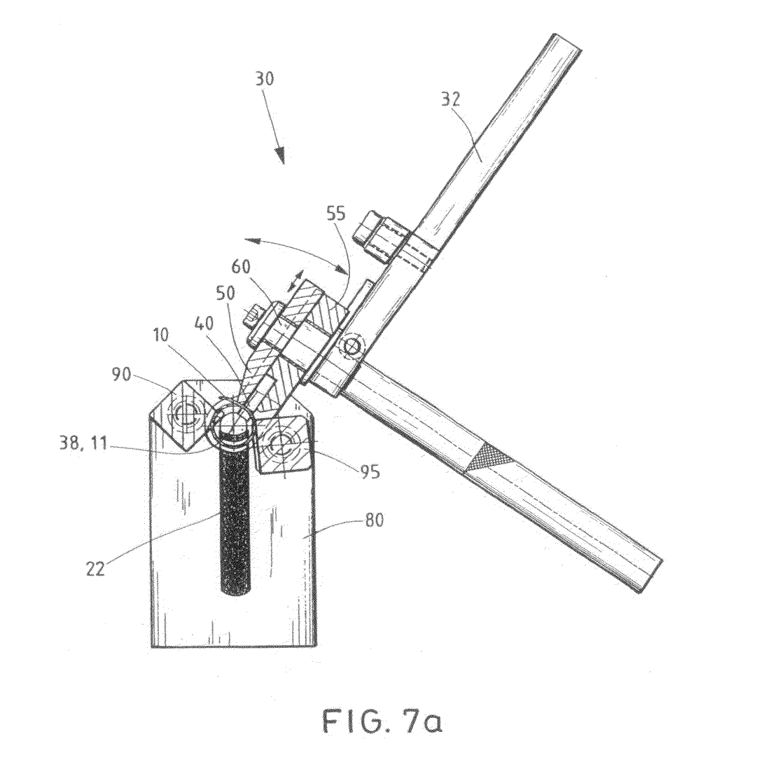

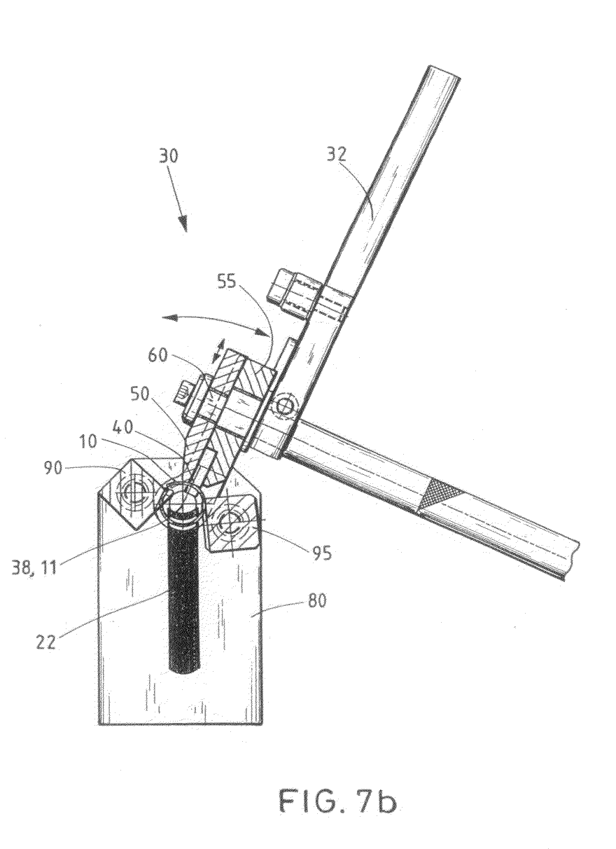

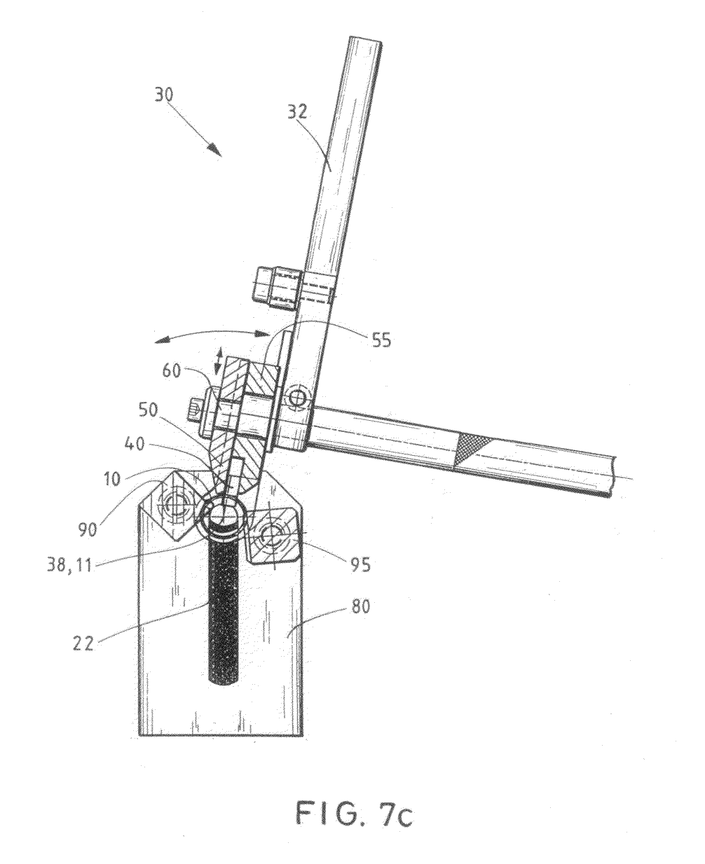

FIGS. 7a through 7c show cross-sections of the working steps to close the wire comb 10 designed with straight tines into a circular O shape. The closing rail 50 of the closing device 30 is hereby pivoted over the pivot point or the central axis 11 of the wire comb center or the wire comb 10 in several steps (see FIGS. 7a, 7b and 7c) so that an approximately circular cross-section gradually results.

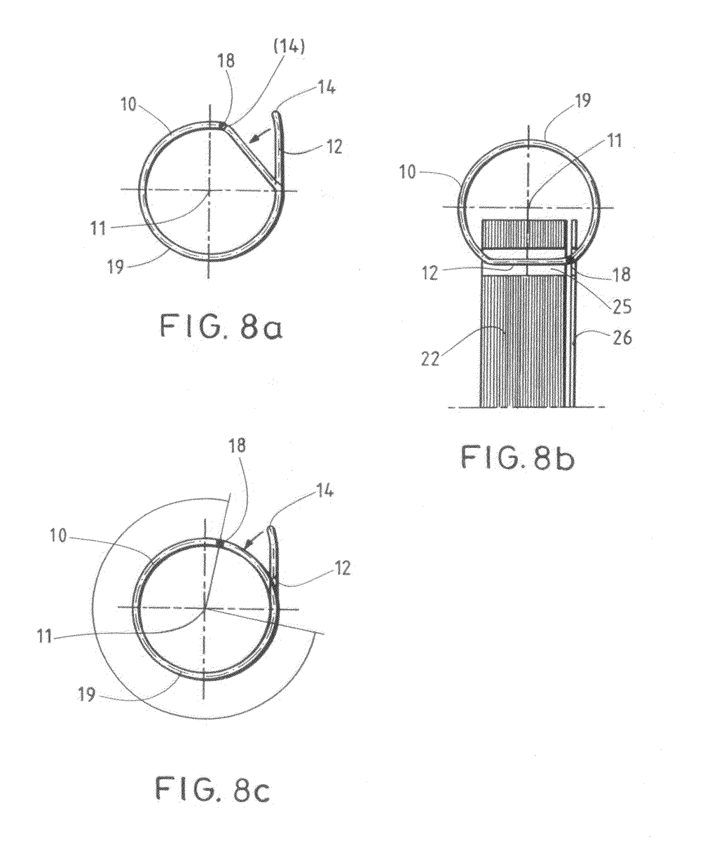

FIG. 8a simultaneously shows a cross-section of the wire comb 10 with the wire bracket or tine 12 closed to a straight line or opened. The straight-line tine 12 is hereby bent such that the tips 14 are arranged between the roots 16 or between the wire lengths 18.

FIG. 8b shows the wire comb 10 with straight tines 12 or wire brackets after turning of the base sheet 26 by 360°. The tines 12 are hereby arranged inside the block 22 so that on the outside the wire comb 10 with its partial-circle-like, preformed back side 19 is visible.

FIG. 8c shows a cross-section of the wire comb 10 with a preformed partial-circle-like shape over more than 270° of the circular shape. The central axis 11 corresponds with the longitudinal axis of the wire comb 10 so that, on the open side with the straight tines 12, the perforations holes 25 of flat parts or paper sheets 24 are mounted on the tines 12.

Through the use of the wire comb 10 according to the invention in the open state with the straight-line tines 12 on the insertion side, it is possible to easily insert and then turn the straight brackets or tines 12 of the wire comb 10 into a squarely aligned block 22. The wire comb 10 is then closed curved or straight.

All named characteristics, including those taken from the drawings alone, and individual characteristics, which are disclosed in combination with other characteristics, are considered alone and in combination as important to the invention. Embodiments according to the invention can be fulfilled through individual characteristics or a combination of several characteristics.

### LIST OF REFERENCES

10 Wire comb
11 Central axis
12 Tines
14 Tips
16 Root
18 Wire length
19 Back side
21 Quadrant
22 Block
24 Paper sheets
25 Perforation holes
26 Base sheet
27 Cover sheet
30 Closing device
32 Activation lever
34 Pin
36 Pin
38 Pivot axis
40 Bending anvil
50 Closing rail
55 Mounting plate
60 Eccentric shaft
80 Plate
82 Plate
90 Receiving rail
95 Receiving rail

What is claimed:

1. A wire comb for the binding of stacked flat parts, comprising:
loop-like or hairpin-like sections insertable into perforations formed in the flat parts;
wire sections arranged next to each other in a longitudinal direction that combine together with the loop-like or hairpin-like sections;
wherein, in an open state before insertion of the loop-like or hairpin-like sections into the perforations, the wire comb has a cross-section in which the loop-like or hairpin-like sections are straight on an insertion side and in which a side facing the straight loop-like or hairpin-like sections is bent or prerounded.

2. The wire comb in accordance with claim 1, wherein the stacked flat part comprise sheets of paper and the perforations are formed in edge areas of the sheets of paper.

3. The wire comb in accordance with claim 2, wherein the side facing the loop-like or hairpin-like section is one of round-bodied or partially circular.

4. The wire comb in accordance with claim 1, wherein, in the open state, the cross-section forms an open “d” or “D” or “P” or “J” and the straight, loop-like or hairpin-like sections are bent on their outer ends, and the wire comb is made of wire.

5. The wire comb in accordance with claim 4, wherein the wire comb is made of metal wire or plastic wire.

6. The wire comb in accordance with claim 1, wherein the bent side is bent or curved over an angle range of at least one of equal to or greater than 180° and equal to or greater than 270°.

7. The wire comb in accordance with claim 1, wherein, in a closed state, the loop-like or hairpin-like sections remain straight or curved.

8. The wire comb in accordance with claim 7, wherein, in the closed state, the flat parts are secured from falling out.

9. A method of binding stacked flat part with the wire comb in accordance with claim 1, wherein the loop-like or hairpin-like sections are inserted into the perforations of the stacked flat part.

10. A method for the binding of stacked flat parts with the wire comb in accordance with claim 1, comprising inserting straight-line, loop-like or hairpin-like sections of an opened wire comb into perforations of the flat parts;
closing the loop-like or hairpin-like sections of the opened wire comb with a pivotable closing device,
wherein a closing device for closing the wire comb is pivoted on a predetermined pivot axis running parallel or collinearly along a longitudinal axis of the wire comb.

11. The method in accordance with claim 10, wherein the stacked flat part comprise sheets of paper and the perforations are formed in edge areas of the sheets of paper.

12. The method in accordance with claim 11, wherein the side facing the loop-like or hairpin-like section is one of round-bodied or partially circular.

13. The method in accordance with claim 10, wherein the loop-like or hairpin-like sections are inserted into the perforations by a handling device, and the method further comprises:
linearly moving the loop-like or hairpin-like sections with the handling device while inserting the loop-like or hairpin-like sections.

14. The method in accordance with claim 10, further comprising capturing or clamping the loop-like or hairpin-like sections in a transition area between the straight-line sections and the prerounded sections with a closing device; and
pivoting the closing device to form a D or O shaped cross-section.

15. The method in accordance with claim 10, wherein the insertion of the loop-like or hairpin-like section and closing of the wire comb is performed by a single device.

16. Apparatus for the binding of stacked flat parts, such as sheets of paper, with a wire comb in accordance with claim 1, comprising:
a pivotable closing device arranged to close the binding, the pivotable closing device being pivotable around a predetermined pivot axis running parallel to or collinear along a longitudinal axis of the wire comb; and
a clamping device being structured and arranged to capture or clamp a transitional area between the loop-like or hairpin-like sections and the prerounded sections.

17. The apparatus in accordance with claim 16, wherein the clamping device comprises projections structured and arranged to engage the loop-like or hairpin-like sections from behind and from inside, and
wherein the projections work together with at least one clamp part positionable on an outside of the loop-like or hairpin-like sections.

18. The apparatus in accordance with claim 17, wherein the projections are hook shaped, and the projections and the at least one clamp part are movable relative to each other.

19. The apparatus in accordance with claim 16, wherein at least one of:
the projections are linearly moveable relative to a longitudinal axis of the wire comb and the at least one clamp part is diagonally movable relative to the longitudinal axis of the wire comb.

20. The apparatus in accordance with claim 19, wherein, for clamping, the projections are movable parallel to the longitudinal axis and the at least one clamp part is movable perpendicularly to the longitudinal axis.

21. The apparatus in accordance with claim 16, further comprising a positioning device for the alignment of the stacked flat parts,
wherein the positioning device further parallelly or collinearly aligns the longitudinal axis of the open wire comb to be inserted into the perforations to the pivot axis.

22. The apparatus in accordance with claim 16, further comprising a handling device arranged for inserting the wire comb into the perforations of the stacked flat parts,
wherein the handling device is linearly movable during the inserting of the wire comb into the perforations.
